(19) United States
(12) Patent Application Publication
(10) Pub. No.: US 2012/0233335 A1
(43) Pub. Date: Sep. 13, 2012

(54) AUXILIARY HOST AND SESSIONS

(75) Inventors: Felix Landry, Gatineau (CA); Justin Newcomb, Kanata (CA); Hamdy Farid, Kanata (CA)

(73) Assignee: ALCATEL LUCENT CANADA INC., Ottawa (CA)

(21) Appl. No.: 13/042,815

(22) Filed: Mar. 8, 2011

(51) Int. Cl. G06F 15/16

(52) U.S. Cl. 709/227

(57) ABSTRACT

A method for establishing a session between a policy and charging rules node (PCRN) and an auxiliary host, includes: receiving, at the PCRN, an application session request message from a packet data network gateway (PGW); establishing an access session with the packet data network gateway; receiving, at the PCRN, an auxiliary session request message from the auxiliary host; and establishing an auxiliary access session with the auxiliary host corresponding to the access session with the packet data network gateway.

### TECHNICAL FIELD

Various exemplary embodiments disclosed herein relate generally to policy and charging in telecommunications networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the Policy and Charging Rules Function (PCRF), Policy and Charging Enforcement Function (PCEF), and Bearer Binding and Event Reporting Function (BBERF) of the EPC. These specifications further provide some guidance as to how these elements interact in order to provide reliable data services and charge subscribers for use thereof.

For example, 3GPP TS 29.212 and 3GPP TS 29.214 provide some guidance on the establishment of an application session by the EPC upon receipt of an application request from an application function (AF) in the form of an AA-Request (AAR) message or from a packet data network gateway (POW) in the form of a Credit Control Request (CCR) message. The standards specify that the PCRF is responsible for receiving new application requests, creating new policy and charging control (PCC) rules commensurate with such requests, and providing these new PCC rules to the PCEF for installation. The 3GPP standards also define the format of application request messages and PCC rules.

### SUMMARY

The 3GPP standards do not contemplate a single PCRF establishing two different IP-CAN sessions in series for a specific subscriber. In view of the foregoing, it would be desirable to provide a method for a PCRF to establish two different IP-CAN sessions with a packet data network gateway (PGW) and an auxiliary host

In light of the present need for a method for a PCRF to establish two different IP-CAN sessions with a packet data network gateway (PGW) and an auxiliary host, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for establishing a session between a policy and charging rules node (PCRN) and an auxiliary host, including: receiving, at the PCRN, an application session request message from a packet data network gateway (PGW); establishing an access session with the packet data network gateway; receiving, at the PCRN, an auxiliary session request message from the auxiliary host; and establishing an auxiliary access session with the auxiliary host corresponding to the access session with the packet data network gateway.

A further exemplary embodiment is directed to a system for establishing sessions between network nodes, comprising: a policy and charging rules node (PCRN) with a Gx interface and an auxiliary Gx interface; a packet data network gateway (PGW) in communication with the PCRN via the Gx interface; an auxiliary host in communication with the PCRN via the auxiliary Gx interface; and an auxiliary host server in communication with PGW and the auxiliary host, wherein the PGW requests an auxiliary host service by sending a request to an auxiliary host server and the auxiliary host server sends an auxiliary host service setup request to the auxiliary host.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary policy and charging rules node (PCRN) for establishing two access sessions in response to application requests;

FIG. 3 illustrates an exemplary network-originated application request message;

FIGS. 4A and 4B illustrate an exemplary user equipment-originated application request message and an auxiliary user equipment originated application request message;

FIG. 5 illustrates establishing two access sessions in response to an application request; and

FIG. 6 illustrates an exemplary subscriber network for providing various data services using multiple packet data network gateways and multiple auxiliary hosts.

### DETAILED DESCRIPTION

Referring now to the drawings, in which like numerals refer to like components or steps, there are disclosed broad aspects of various exemplary embodiments.

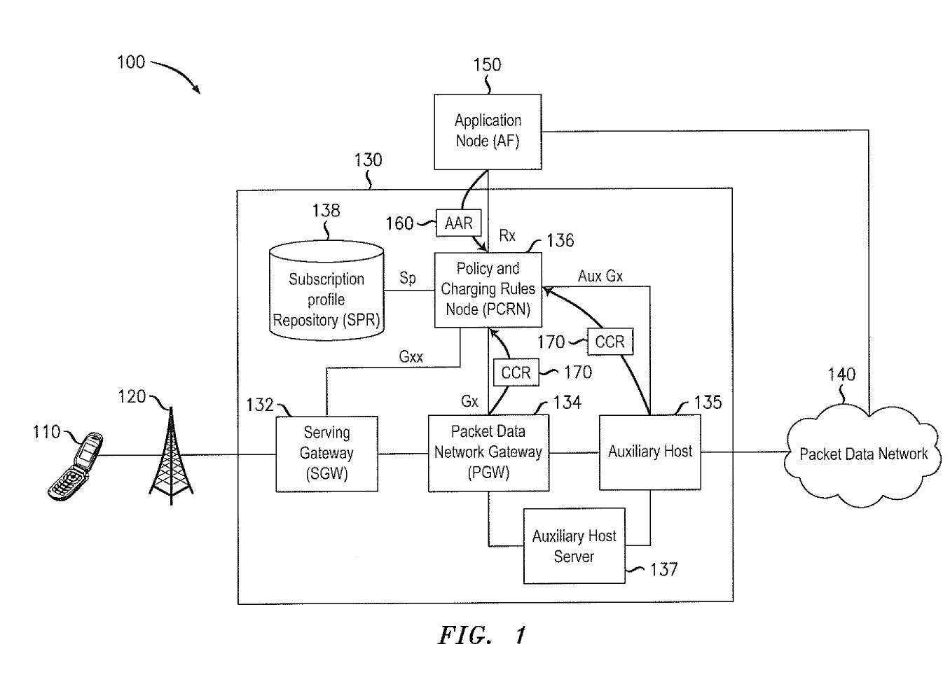

FIG. 1 illustrates an exemplary subscriber network 100 for providing various data services. Exemplary subscriber network 100 may be telecommunications network or other network for providing access to various services. Exemplary subscriber network 100 may include user equipment 110, base station 120, evolved packet core (EPC) 130, packet data network 140, and application function (AF) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, an auxiliary host 135, a policy and charging rules node (PCRN) 136, an auxiliary host server 137, and a subscription profile repository (SPR) 138.

Serving gateway (SGW) 132 may be a device that provides gateway access to the EPC 130. SGW 132 may be the first device within the EPC 130 that receives packets sent by user equipment 110. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, and subscriber charging support. PGW 134 may also be responsible for requesting resource allocation for unknown application services. As will be described in further detail below with respect to FIG. 4, upon receiving a request for an unknown application service from UE 110, PGW may construct a credit control request (CCR), such as CCR 170, requesting an appropriate allocation of resources and forward the request to PCRN 136.

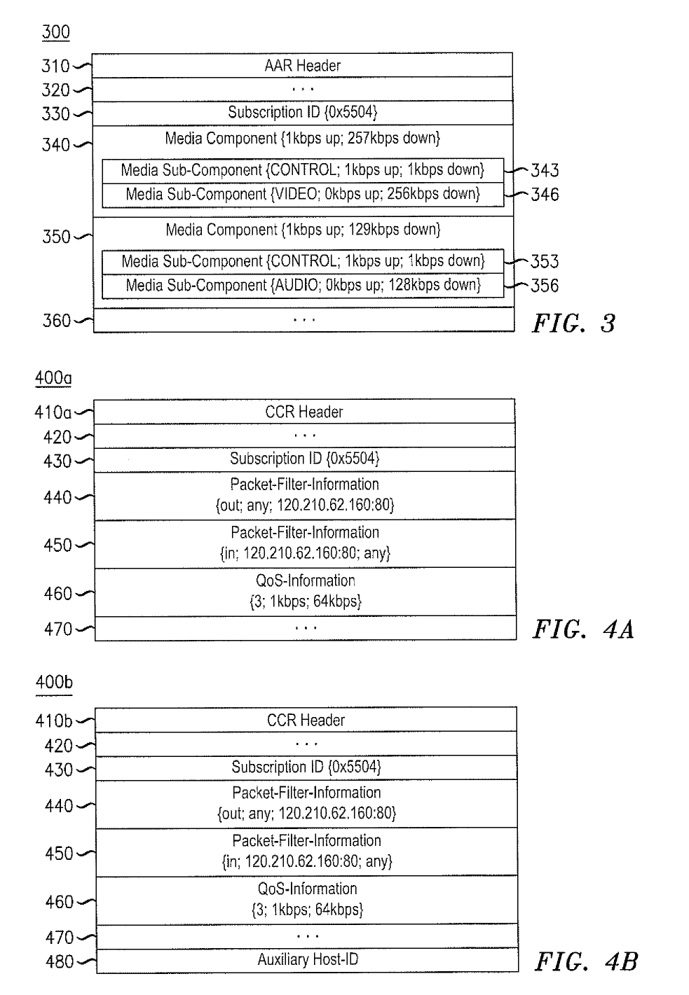

Policy and charging rules node (PCRN) 136 may be a device that receives requests for application services, generates PCC rules, and provides PCC rules to the PGW 134, auxiliary host 135, and/or other PCENs (not shown). PCRN 136 may be in communication with AF 150 via an Rx interface. As described in further detail below with respect to AF 150 and FIG. 3, PCRN 136 may receive an application request in the form of an AA-Request (AAR) 160 from AF 150. Upon receipt of AAR 160, PCRN 136 may generate at least one new PCC rule for fulfilling the application request 160.

PCRN 136 may also be in communication with SGW 132 and PGW 134 via a Gxx and a Gx interface, respectively. As described in further detail below with respect to FIG. 4, PCRN 136 may receive an application request in the form of a credit control request (CCR) 170 from SGW 132 or PGW 134. As with AAR 160, upon receipt of CCR 170, PCRN may generate at least one new PCC rule for fulfilling the application request 170. In various embodiments, AAR 160 and CCR 170 may represent two independent application requests to be processed separately, while in other embodiments, AAR 160 and CCR 170 may carry information regarding a single application request and PCRN 136 may create at least one PCC rule based on the combination of AAR 160 and CCR 170. In various embodiments, PCRN 136 may be capable of handling both single-message and paired-message application requests.

Upon creating a new PCC rule or upon request by the PGW 134, PCRN 136 may provide a PCC rule to PGW 134 via the Gx interface. In various embodiments, such as those implementing the PMIP standard for example, PCRN 136 may also generate QoS rules. Upon creating a new QoS rule or upon request by the SGW 132, PCRN 136 may provide a QoS rule to SGW 132 via the Gxx interface.

Further, the PCRN 136 may also be in communication with auxiliary host 135 via an auxiliary Gx interface. The auxiliary Gx interface operates like the Gx interface with the exception of an additional field used to identify the auxiliary host. This auxiliary host ID may be simply added at the end of a typical Gx message and may include a text string that uniquely identifies the type of device that is the auxiliary host 135, e.g. brand and model of device. For example, a Diameter Proxy Agent (DPA) in the PCRN 136 may insert the auxiliary host ID in the last data field of the CRR. Any other method of identifying the auxiliary host 135 may be used as well. PCRN 136 may also receive an application request in the form of a credit control request (CCR) 170 from the auxiliary host 135. PCRN 136 may then generate at least one new PCC rule for fulfilling the application request 170. This additional CCR 170 will typically correspond to a CCR from the PGW 134. This allows both the PGW 134 and auxiliary host 135 to be used together to support a subscriber. The auxiliary host 135 may be for example a deep packet inspection (DPI) unit, shaper unit, parental control gateway, charging gateway, media adaptation transcoder, etc.

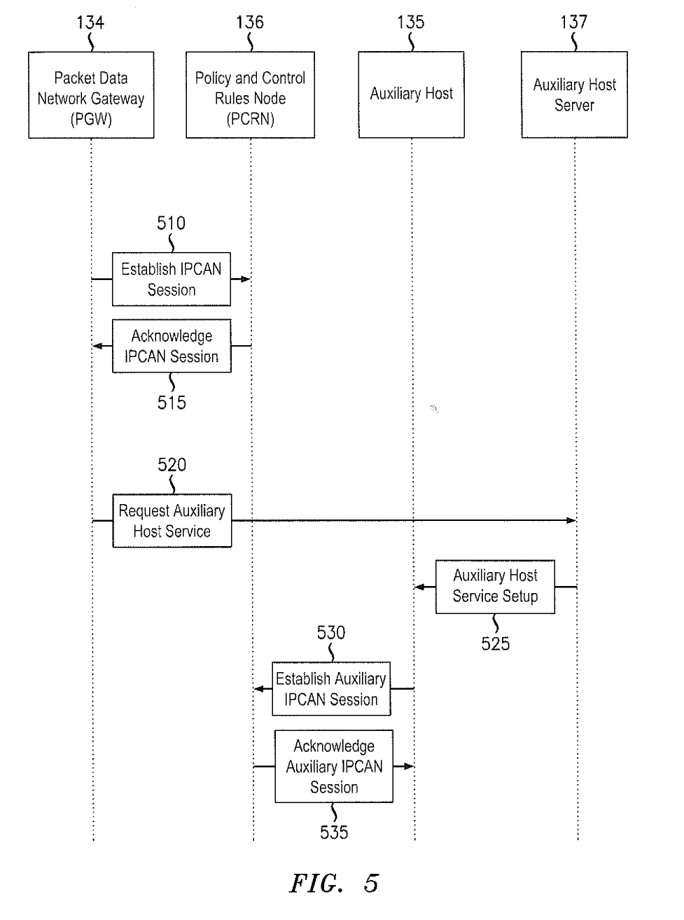

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. As will be described in further detail with reference to FIG. 5, data stored by SPR 138 may include an identifier of each subscriber and indications of subscription information for each subscriber such as bandwidth limits, charging parameters, and subscriber priority.

The auxiliary host server 137 receives a service request from the PGW 134. The auxiliary host server 137 then sends a message to the auxiliary host 135 to request the services of the host, for example, DPI. The auxiliary host 135 may use the Radius AAA communication protocol to communicate with the auxiliary host server 137 which would be a Radius server. Depending upon the communication protocol implemented in the auxiliary host 135, other protocols may be used to communicate with the auxiliary host 135. In other configurations, the auxiliary host server 137 may not be necessary, as the PGW 134 may be able to directly communicate with the auxiliary host 135. The operation of the auxiliary host 135 and the auxiliary host server 137 will be discussed in further detail below.

Packet data network 140 may be any network for providing data communications between user equipment 110 and other devices connected to packet data network 140, such as AF 150. Packet data network 140 may further provide, for example, phone and/or Internet service to various user devices in communication with packet data network 140.

Application function (AF) 150 may be a device that provides a known application service to user equipment 110. Thus, AF 150 may be a server or other device that provides, for example, a video streaming or voice communication service to user equipment 110. AF 150 may further be in communication with the PCRN 136 of the EPC 130 via an Rx interface. When AF 150 is to begin providing known application service to user equipment 110, AF 150 may generate an application request message, such as an AA-Request (AAR) 160 according to the Diameter protocol, to notify the PCRN 136 that resources should be allocated for the application service. This application request message may include information such as an identification of the subscriber using the application service and an identification of the particular service data flows that must be established in order to provide the requested service. AF 150 may communicate such an application request to the PCRN 136 via the Rx interface.

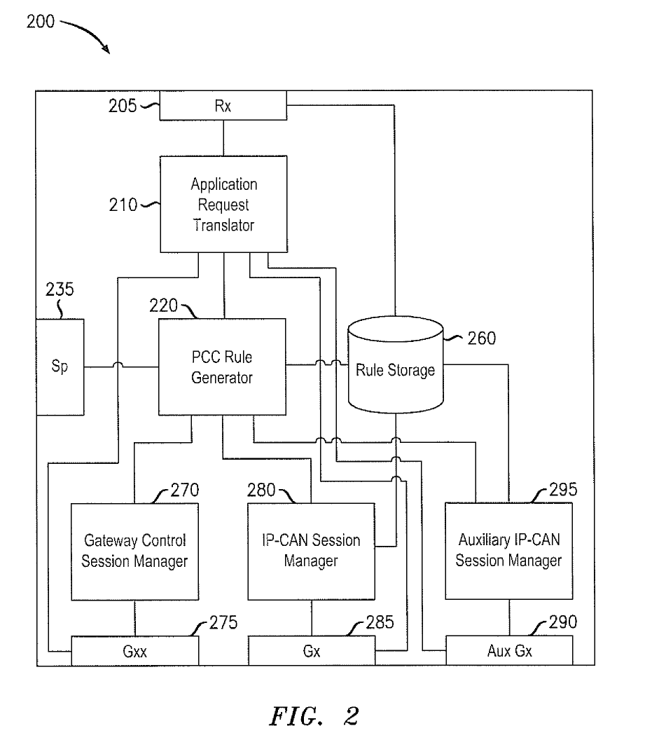

Having described the components of subscriber network 100, a brief summary of the operation of subscriber network 100 will be provided. It should be apparent that the following description is intended to provide an overview of the operation of subscriber network 100 and is therefore a simplification in some respects. The detailed operation of subscriber network 100 will be described in further detail below in connection with FIGS. 2-5.

FIG. 2 illustrates an exemplary policy and charging rules node (PCRN) 200 for creating new policy and charging control (PCC) rules in response to application requests. PCRN 200 may correspond to PCRN 136 of exemplary subscriber network 100. PCRN 200 may include an Rx interface 205, application request translator 210, PCC rule generator 220, Sp interface 235, rule storage 260, gateway control session manager 270, Gxx interface 275, IP-CAN session manager 280, Gx interface 285, auxiliary IP-CAN session manager 295, and auxiliary Gx interface 290.

Rx interface 205 may be an interface comprising hardware and/or executable instructions encoded on a machine-readable storage medium configured to communicate with an AF such as AF 150. Such communication may be implemented according to the 3GPP TS 29.214. Specifically, Rx interface 205 may receive an application request (AAR) from AF 150.

Application request translator 210 may include hardware and/or executable instructions on a machine-readable storage medium configured to determine from an application request, whether it be an AAR, CCR, or combination thereof, what service data flows will be necessary to provide a requested service. As will be described in greater detail below with respect to FIGS. 3-4, an application request may identify a number of streams needed to provide the requested service. Application request translator 210 may then generate a service flow object to represent each requested data stream. Each service flow object may include information described by the application request such as, for example, requested bandwidth, packet filter, subscriber identifier, and/or data stream type. Application request translator 210 may then pass each service flow object to PCC rule generator 220 for further processing.

PCC rule generator 220 may include hardware and/or executable instructions on a machine-readable storage medium configured to generate a new PCC rule based on a received application request and/or a service flow object generated by the application request translator 210. PCC rules are forwarded to IP-CAN session manager 280 and auxiliary IP-CAN session manager 295 for installation. In various embodiments utilizing gateway control sessions to provide QoS assurance, such as an embodiment utilizing PMIP, PCC rule generator 220 may also forward the PCC rules to gateway control session manager 270.

Sp interface 235 may be an interface comprising hardware and/or executable instructions encoded on a machine-readable storage medium configured to communicate with a SPR such as SPR 138. Thus, Sp interface 235 may transmit record requests and receive subscription profile records.

Gateway control session manager 270 may include hardware and/or executable instructions on a machine-readable storage medium configured to generate and transmit QoS rules for installation at an SGW or other node implementing a gateway control session. In various embodiments utilizing gateway control sessions to provide QoS assurance, such as an embodiment utilizing PMIP, gateway control session manager 270 may extract information necessary to generate a QoS rule from a PCC rule. For example, gateway control session manager 270 may extract the rule name, service data flow filter, and QoS parameters from a PCC rule and generate a new QoS rule. Gateway control session manager 270 may then forward the new QoS rule to an SGW or other appropriate node via Gxx interface 275.

Gxx interface 275 may be an interface comprising hardware and/or executable instructions encoded on a machine-readable storage medium configured to communicate with a SGW such as SGW 132. Such communication may be implemented according to the 3GPP TS 29.212. Thus, Gxx interface 275 may receive requests for QoS rules and transmit QoS rules for installation. Gxx interface 275 may further receive UE-originated application requests in the form of a CCR.

IP-CAN session manager 280 may include hardware and/or executable instructions on a machine-readable storage medium configured to transmit a new PCC rule to a PGWor other node implementing a PCEF. IP-CAN session manager 280 may receive a new PCC rule and immediately forward it to a PGW or other node via Gx interface 285. IP-CAN session manager 280 may perform additional functionality such as, for example, receiving requests for rules via Gx interface 285 and responding by retrieving the requested rule from rule storage 260 and transmitting it via the Gx interface 285.

Auxiliary IP-CAN session manager 295 may include hardware and/or executable instructions on a machine-readable storage medium configured to transmit a new PCC rule to an auxiliary host. Auxiliary IP-CAN session manager 295 may receive a new PCC rule and immediately forward it to the auxiliary host 135 via auxiliary Gx interface 290. Auxiliary IP-CAN session manager 295 may perform additional functionality such as, for example, receiving requests for rules via auxiliary Gx interface 290 and responding by retrieving the requested rule from rule storage 260 and transmitting it via the auxiliary Gx interface 290.

Gx interface 285 may be an interface comprising hardware and/or executable instructions encoded on a machine-readable storage medium configured to communicate with a PGW such as PGW 134. Auxiliary Gx interface 290 may be an interface comprising hardware and/or executable instructions encoded on a machine-readable storage medium configured to communicate with an auxiliary host such as auxiliary host 135. Such communication may be implemented according to the 3GPP TS 29.212. As discussed above, the auxiliary Gx interface 290 may be the same as the Gx interface 285, but with the addition of an auxiliary host ID field. Thus, Gx interface 285 and auxiliary interface 290 may receive requests for PCC rules and transmit PCC rules for installation. Gx interface 285 and auxiliary Gx interface 290 may further receive UE-originated application requests in the form of a CCR, such as CCR 170.FIG. 3 illustrates an exemplary network-originated application request message in the form of an AAR 300. AAR 300 may be constructed according to the Diameter message protocol and/or 3GPP TS 29.214. Accordingly, AAR 300 may include a header 310, subscription ID field 330, media component fields 340, 350, and a number of additional fields 320, 360. Note that the order of the fields of AAR 300 may vary. Thus, for example, subscription ID field 330 may be located after media component fields 340, 350.

Header 310 may be a standard Diameter header indicating that message 300 is an AAR. Thus, header 310 may include a command code field set to a value of 265 and the R-bit field of the command flags field set, as provided for by the Diameter protocol and 3GPP TS 29.214.

Subscription ID field 330 may be an attribute-value pair (AVP) for indicating a subscription that is associated with the particular request. For example, subscription ID field 330 indicates that the subscription identified by the value “0x5504” is associated with AAR 300. This information may be used to access a subscription profile record and charge the appropriate subscriber in relation to the requested service.

Media component fields 340, 350 may contain service information related to each media component of a requested service. In the example of AAR 300, the request may be for a streaming video. Media component 340 may correspond to the video portion of the stream while media component 350 may correspond to the audio portion of the stream. Each media component may carry further description such as, for example, the requested bandwidth for each portion of the stream. Thus, media component 340 may request 1 kbps upstream and 257 kbps downstream for the video portion while media component 350 may request 1 kbps upstream and 129 kbps downstream for the audio portion.

Media component fields 340, 350 may further include media sub-components 343, 346, 353, 356, each indicating an independent data stream necessary for providing the requested service. Thus, media sub-component 343 may indicate that a control stream having bandwidth of 1 kbps upstream and 1 kbps downstream is necessary for providing a streaming video. Likewise, media sub-component 346 may indicate that a video stream having 256 kbps downstream bandwidth is also necessary for a streaming video. Media-subcomponents 353, 356 may similarly indicate that a control stream having 1 kbps bandwidth in both directions and an audio stream having 128 kbps downstream are necessary for providing the audio component of the streaming video.

Additional fields 320, 360 may include additional information as specified by the Diameter protocol and/or 3GPP TS 29.214. Thus, additional fields 320, 360 may include additional attribute value pairs (AVPs) such as the Origin-Host AVP, Destination-Host AVP, Supported-Features AVP, Framed-IP-Address AVP, etc. Additional fields 320, 360 may be used in extracting other useful information such as, for example, flow identifying information.

FIG. 4A illustrates an exemplary user equipment-originated application request message in the form of a CCR 400a. FIG. 4B illustrates an exemplary user equipment-originated application request message in the form of a CCR 400b. CCRs 400a, 400b may be constructed according to the Diameter message protocol and/or 3GPP TS 29.212. Accordingly, CCRs 400a, 400b may include a header 410, subscription ID field 430, packet filter information fields 440, 450, QoS information field 460, and a number of additional fields 420, 470. Note that the order of the fields of CCR 400 may vary. Thus, for example, subscription ID field 430 may be located after packet filter information fields 440, 450, or QoS information field 460.

Header 410 may be a standard Diameter header indicating that message 400 is a CCR. Thus, header 410 may include a command code field set to a value of 258 and the R-bit field of the command flags field set, as provided for by the Diameter protocol and 3GPP TS 29.212.

Subscription ID field 430 may be an attribute-value pair (AVP) for indicating a subscription that is associated with the particular request. For example, subscription ID field 430 indicates that the subscription identified by the value “0x5504” is associated with CCR 400. This information may be used to access a subscription profile record and charge the appropriate subscriber in relation to the requested service.

Packet filter information fields 440, 450 may contain service information related to each requested flow for the requested service. In various embodiments, such as those implementing LTE for example, packet filter information fields 440, 450 may be Packet-Filter-Information AVPs. In various embodiments, such as those implementing GPRS for example, packet filter information fields 440, 450 may be TFP-Packet-Filter-Information AVPs. In the example of CCR 400, the request may be, for example, for HTTP server traffic. Packet filter information field 440 may describe a downstream flow, as indicated by the ‘out’ value, for traffic destined for IP address 120.210.62.160 on port 80 from any source. Likewise, packet filter information field 450 may describe an upstream flow, as indicated by the ‘in’ value, for traffic sent from IP address 120.210.62.160 on port 80 to any destination. Packet filter information fields 440, 450 may contain additional information such as, for example, a type of service, traffic class, and/or flow label.

QoS information field 460 may contain requested QoS settings for the requested service flows. For example, QoS information field 460 may indicate that the flows requested by CCR 400 should have an allocation retention priority of 3 and a maximum bandwidth of 1 kbps upstream and 64 kbps downstream. QoS information field 460 may contain additional information such as, for example, a QCI, guaranteed bandwidths, and/or a bearer identifier.

In various exemplary embodiments, PCRN 200 may not use QoS information field 460 to determine QoS values when generating a PCC rule. In such embodiments, a PGW such as PGW 134 may include QoS information within the packet filter information fields and PCRN 200 may use this information in the generation of a PCC rule instead.

Additional fields 420, 470 may include additional information as specified by the Diameter protocol and/or 3GPP TS 29.212. Thus, additional fields 420, 470 may include additional attribute value pairs (AVPs) such as the CC-Request-Type AVP, Framed-IP-Address AVP, 3GPP-SGSN-Address AVP, etc. Additional fields 420, 470 may be used in extracting other useful information such as, for example, flow identifying information.

The auxiliary host ID field 480 is included in a CCR received by the PCRN 136. The auxiliary host ID field 480 uniquely identifies the type of device that is the auxiliary host 135, e.g. brand and model of device. This field may be implemented using a text string or any other method of indentifying the auxiliary host 135. The DPA will recognize that the CCR is from an auxiliary host 135 and may insert the auxiliary host ID in the CRR.

FIG. 5 illustrates the establishment of two access sessions in response to an application request. PGW 134 sends a CCR 170 to the PCRN 136 to establish an access session 510 such as an IPCAN session. The PCRN 136 processes the CCR 170, establishes the IPCAN session, and sends an acknowledgement 515 back to the PGW 134. The POW 134 also requests an auxiliary host service 520 by sending a request to the auxiliary host server 137. The auxiliary host server 137 may be a Radius server. The auxiliary host server 137 then sends a CCR message to the auxiliary host 135 to set up the requested auxiliary host service. The auxiliary host 135 then establishes another access session 530. This session may be an IPCAN session as well, but the CCR will include the auxiliary host ID 480 information. The PCRN 136 processes the CCR 170, establishes the second IPCAN session, and sends an acknowledgement 535 back to the auxiliary host 135.

In addition to the establishment of IP-CAN sessions, new PCC rules may be pushed to the PGW 134 via the Gx interface 285 and the auxiliary host 135 via the auxiliary Gx interface 290 when those rules change. For example, usage management events, SPR changes, WNG events, CCR update messages, or any other non-AF network event may lead to a change in PCC rules. It should be noted that it is possible for the two IPCAN sessions to be set up in any order. The PCRN 136 will perform a check to see if there are two IPCAN sessions for any given subscriber and if so will associate those two sessions together so that any changes to the PCC rules can be pushed down both of the IPCAN sessions. This has the advantage of not requiring a second PCRN 136 to separately manage the auxiliary host. Such an approach would add cost and complexity to the system. Further, it is more challenging to coordinate the PCC rules for PGW 134 and auxiliary host 135 if they are controlled by two separate PCRNs. Also, if a carrier already has existing equipment in the network, for example a DPI, now this DPI can be used with the PCRN 136 via the auxiliary Gx interface 290 without the need for an additional PCRN 136.

The PCRN also provides audit services to verify that, if needed, both IPCAN sessions between the PCRN and PGW 134 and auxiliary host 135 have been established. If not, the PCRN may then stop the orphaned IPCAN session.

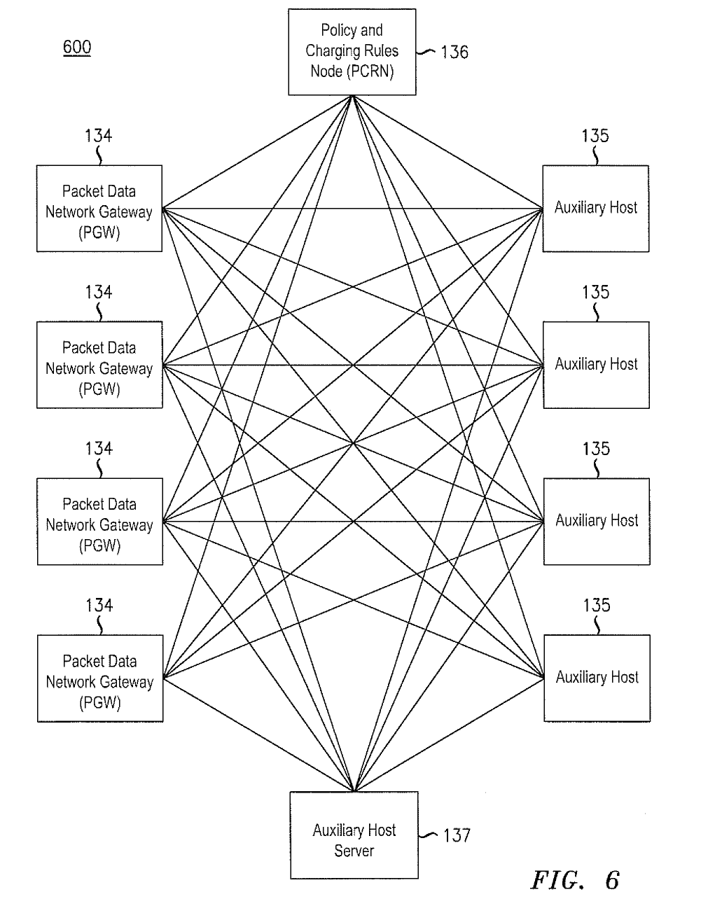

FIG. 6 illustrates an exemplary subscriber network for providing various data services using multiple PGWs 134 and multiple auxiliary hosts 135. The network may include multiple PGWs 134 and multiple auxiliary hosts 135 all controlled by a single PCRN 136. Such an arrangement allows the PCRN 136 to spread the subscriber service requests across the plurality of PGWs 134 and auxiliary hosts 135 based upon availability and loading. Any available auxiliary host 135 may be associated with a PGW 134 providing services to a specific subscriber. For a different subscriber, that auxiliary host 135 may be associated with a different PGW 134. Further, a single auxiliary host server 137 may be used to communicate between any of the multiple PGWs 134 and multiple auxiliary hosts 135. Further, multiple auxiliary hosts 135 may be associated with a single PGW 134. These multiple auxiliary hosts 135 may each provide additional services in conjunction with the PGW 134. Therefore, the PCRN 136 may establish multiple auxiliary IP-CAN sessions between the PCRN 136 and the auxiliary hosts 135.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method for establishing a session between a policy and charging rules node (PCRN) and an auxiliary host, the method comprising:
receiving, at the PCRN, an application session request message from a packet data network gateway (PGW);
establishing an access session with the packet data network gateway;
receiving, at the PCRN, an auxiliary session request message from the auxiliary host; and
establishing an auxiliary access session with the auxiliary host corresponding to the access session with the packet data network gateway.

2. The method of claim 1, wherein the auxiliary session request message includes an auxiliary host ID.

3. The method of claim 1, wherein receiving the application session request message from the PGW includes receiving the message at a Gx interface using the Diameter protocol and wherein the application session request message from the PGW is a CCR message.

4. The method of claim 1, wherein receiving the auxiliary session request message from the auxiliary host includes receiving the message at an auxiliary Gx interface using the Diameter protocol and wherein the application session request message from the PGW is a CCR message.

5. The method of claim 1, wherein the PGW requests an auxiliary host service by sending a request to the auxiliary host.

6. The method of claim 5, wherein the auxiliary host server is a Radius server using the Radius protocol.

7. The method of claim 1, further comprising auditing the auxiliary access session to determine that there is a corresponding access session wherein the auxiliary access session is canceled if a corresponding access session is not identified.

8. A machine-readable storage medium encoded with instructions for execution on a policy and charging rules node (PCRN) for establishing a session between the PCRN and an auxiliary host, the machine-readable storage medium comprising:
instructions for receiving, at the PCRN, an application session request message from a packet data network gateway (PGW);
instructions for establishing an access session with the packet data network gateway;
instructions for receiving, at the PCRN, an auxiliary session request message from the auxiliary host; and
instructions for establishing an auxiliary access session with the auxiliary host corresponding to the access session with the packet data network gateway.

9. The machine-readable storage medium of claim 8, wherein the auxiliary session request message includes an auxiliary host ID.

10. The machine-readable storage medium of claim 8, wherein receiving the application session request message from the PGW includes receiving the message at a Gx interface using the Diameter protocol and wherein the application session request message from the PGW is a CCR message.

11. The machine-readable storage medium of claim 8, wherein receiving the auxiliary session request message from the auxiliary host includes receiving the message at an auxiliary Gx interface using the Diameter protocol and wherein the application session request message from the PGW is a CCR message.

12. The machine-readable storage medium of claim 8, further comprising auditing the auxiliary access session to determine that there is a corresponding access session wherein the auxiliary access session is canceled if a corresponding access session is not identified.

13. The machine-readable storage medium of claim 8, wherein receiving the application session request message from the PGW includes receiving the message at a Gx interface using the Diameter protocol and wherein the application session request message from the PGW is a CCR message.

14. A system for establishing sessions between network nodes, comprising:
a policy and charging rules node (PCRN) with a Gx interface and an auxiliary Gx interface;
a packet data network gateway (PGW) in communication with the PCRN via the Gx interface;
an auxiliary host in communication with the PCRN via the auxiliary Gx interface; and
an auxiliary host server in communication with PGW and the auxiliary host, wherein the PGW requests an auxiliary host service by sending a request to an auxiliary host server and the auxiliary host server sends an auxiliary host service setup request to the auxiliary host.

15. The system of claim 14, further comprising a serving gateway (SGW) in communication with the PCRN via a Gxx interface in the PCRN.

16. The system of claim 14, wherein the Gx interface and the auxiliary Gx interface use the Diameter protocol and wherein an application session request message from the PGW is a CCR message.

17. The system of claim 16, wherein the CCR message sent by the auxiliary host to the PCRN includes an auxiliary host ID.

18. The system of claim 14, wherein the auxiliary host server is a Radius server using the Radius protocol.

19. The system of claim 14, where the PCRN establishes an access session with the PGW and an auxiliary session with the auxiliary host.

20. The system of claim 19, where the PCRN audits the auxiliary access session to determine that there is a corresponding access session wherein the auxiliary access session is canceled if a corresponding access session is not identified.

21. The system of claim 19 wherein access session and the auxiliary access session are IPCAN sessions.
